(19) United States
(12) Patent Application Publication
(10) Pub. No.: US 2006/0016917 A1
(43) Pub. Date: Jan. 26, 2006

(54) Apparatus for applying seed to a ground surface

(76) Inventors: Forest W. Moore, Clemmons, NC (US); Mark B. Throne, Clemmons, NC (US)

Correspondence Address: Charles Y. Lackey, PO Box 5871, Winston-Salem, NC, 27113-5871, US

(21) Appl. No.: 10/895,752

(22) Filed: Jul. 22, 2004

(51) Int. Cl. A01C 15/00

(52) U.S. Cl. 239/650

(57) ABSTRACT

A portable seed spreading apparatus is designed to be used with a conventional pneumatic blower. A hose has one end connected to the blower and the other end formed into a shaped nozzle. A receptacle is used to hold a supply of seeds and has a connector extending into the hose between its ends. The connector is operable to receive airflow from the blower and direct seed flow from the receptacle into the airflow within the hose and out of the hose through the nozzle.

### BACKGROUND OF THE INVENTION

1. Field of the Invention

The present invention relates to ground care and planting and, more particularly, to an apparatus for applying seed to a ground surface.

2. Description of the Prior Art

Ground surface preparation and maintenance are regular and common activities relating to the upkeep and appearance of home lawns, parks, highways and the like. While there are many devices designed to assist in such activities, there are relatively few designed to apply seed and related supporting materials to a specific ground surface in a rapid and extensive manner. The existing devices are sometimes cumbersome and time consuming to use. Thus lawn care continues to be a labor intensive activity.

There are a few devices such as the broadcast type spreader designed to assist in providing a cover of agriculture seed or supporting materials such as fertilizer over a lawn surface. One such device is comprised generally of a receptacle within which to place the seed which is mounted on a pair of wheels and has a number of small openings at its bottom. A plurality of blades rotate about an axis running across the lower end of the receptacle forcing the seed out of the openings in the bottom of the receptacle. A handle extends upwardly from the receptacle so that the user can grasp and displace the handle and make the device operate. The user then moves back and forth over the ground surface to be covered to apply the seed or material. Alternatively, the device may be operated by mounting it to the back of a vehicle and pulling it over the ground surface.

Other materials or fertilizer compositions are not suited for use with such devices and thus need to be applied manually. In the manual application, one must take handfuls of seed or material and sprinkle it over patches of or perhaps all of the lawn. Devices used for this activity are also cumbersome and time consuming to use. Their limitations are even more apparent in industrial applications such as parks, highways and stadium fields where there is a much greater surface to be covered.

Thus, while devices have been developed that aid in the spreading of seed or supporting materials, none completely solve the problem of providing an easy, fast and efficient way for the user to spread seed or supporting materials evenly over the ground surface. The user must walk back and forth over the area intended to be covered spreading the seed slowly over the ground surface. The seed or supporting materials are often applied in a non-uniform manner so that the spread materials may be thicker in some areas than in others.

A desired apparatus for spreading seed and other materials over lawns and the like should be powerful, portable, easy to use and efficient. It is to this desired objective that the present invention is directed.

### SUMMARY OF THE INVENTION

The present invention is a portable apparatus for applying seed or supporting materials to a ground surface which is particularly adapted for use with a conventional pneumatic blower. The blower has a hose with a first end operably connected with blower and a second end forming a selectively shaped nozzle. A receptacle having a removable and reclosable top which is operable to permit introduction and retention of seed within the receptacle and a discharge end operable to permit the selectively controlled and measured removal of seed or supporting materials from the receptacle for distribution onto a ground surface. A blower/hose connector extends from the blower to the hose and connects to the hose between the hose first and second ends and is operable to receive air flow from the blower through the hose and permit seed flow through an opening having a movable baffle cooperatively functioning therewith in response to the movement of a flow adjusting switch.

From the foregoing summary, it can be seen that a primary objective of the present invention is to provide a portable, self-contained seed applying apparatus that has all of the advantages, and more, of prior art devices and none of the disadvantages, which is easy and efficient to use and which is simple and inexpensive to manufacture.

### BRIEF DESCRIPTION OF THE FIGURES

FIG. 1 is perspective view of one embodiment of the invention showing the seeding apparatus fully assembled;

FIG. 2 is a perspective disassembled view without the blower of the apparatus shown in FIG. 1 showing the hose first end, the blower/hose connector, the hose second end, a first receptacle connected to the blower/hose connector and a second alternatively configured receptacle; and

FIG. 3 is a side elevational, perspective and partially hidden view of yet another configured receptacle illustrating its connecting relationship with the hose.

### DETAILED DESCRIPTION OF THE PREFERRED EMBODIMENT

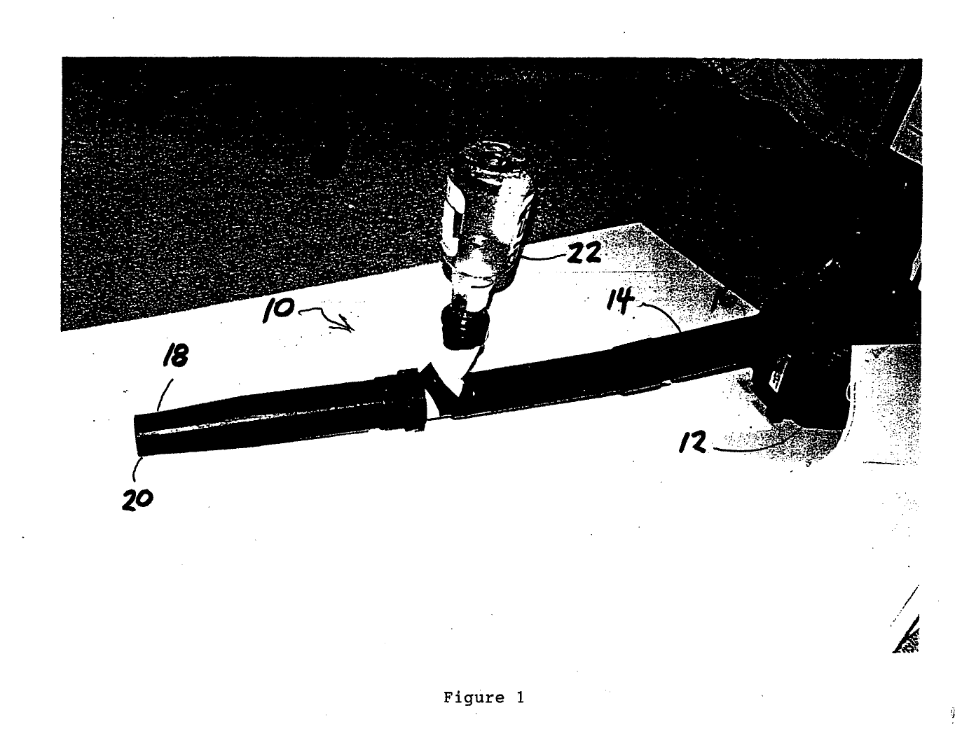

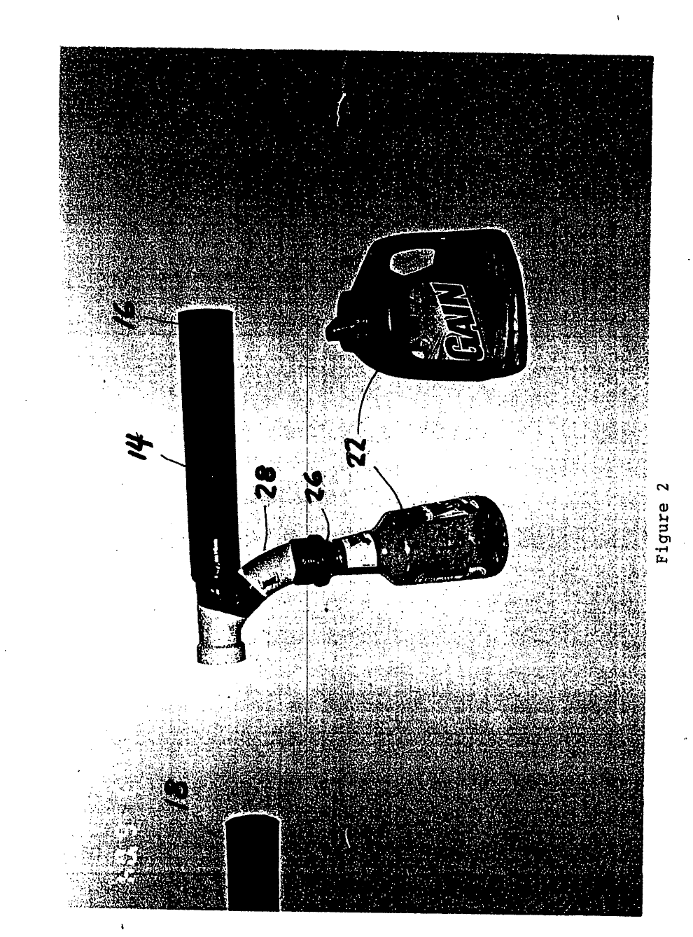

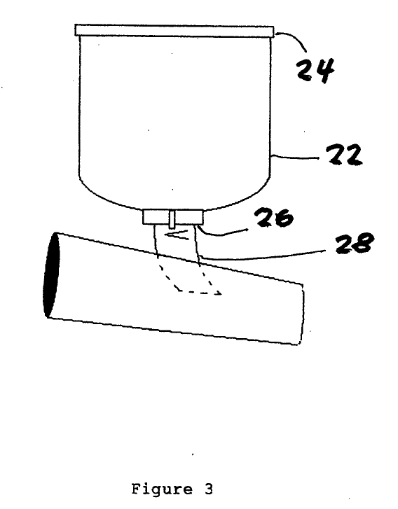

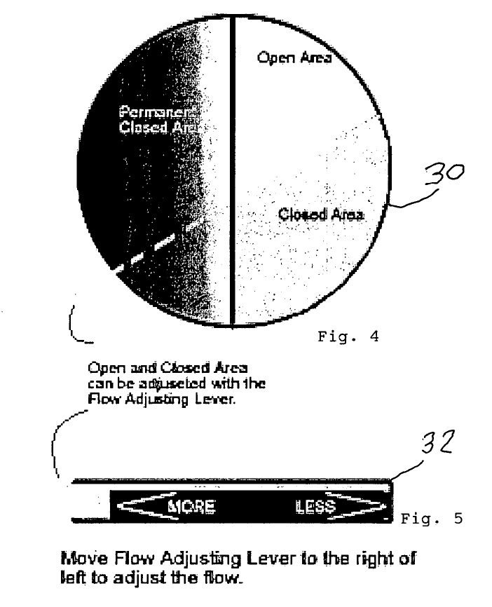

Referring now to the drawings and particularly to FIG. 1, it can be seen that in one embodiment, an apparatus 1o includes a self-contained motorized blower 12 and a hose 14 one end of which 16 connects operably with blower 12 and the other end of which 18 contains a selectively shaped nozzle 20. A receptacle 22 has a removable and resealable top 24 which can be opened to receive a quantity of seed or other supporting materials and closed to retain the seed or materials within receptacle 22. Receptacle 22 also has a discharge end 26 which accommodates the controlled and measured removal of seed or other materials from receptacle 22 onto the ground surface (not shown).

A blower/hose connector 28 extends from blower 12 to hose 14 connecting therewith between hose first end 16 and hose second end 18 in a manner operable to receive air flow from blower 12 through hose 14 and permit seed flow from receptacle 22 into the air flow within hose 14.

A seed flow control device 30 is positioned in connector 28 and includes a baffle adjustable with respect to the opening to regulate the amount of seeds being discharged.

From the proceeding description, it can be seen that a seed applying flow apparatus been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. Apparatus for applying seed to the ground surface comprising: a self-contained motorized blower; a blower hose having a first end extending from the blower and a second end forming a selectively shaped nozzle; a receptacle having a removable and resalable top operable to permit the introduction of seed within the receptacle and a discharge end operable to permit the selectively controlled and measured removal of seed from the receptacle for distribution onto the ground surface; blower/hose connecting means extending from the blower to the hose and connecting to the hose between the hose first and second ends operable to receive air flow from the blower through the hose and permit seed flow from the receptacle into the air flow within the hose; and seed flow control means associated with the blower and the receptacle.

2. Apparatus as claimed in claim 1 wherein the receptacle is releasably securable to the hose.

3. Apparatus as claimed in claim 2 wherein the hose first and second ends can be secured to each other after the receptacle has been removed so that the apparatus can operate as an air blower.

4. Apparatus as claimed in claim 1 wherein the air flow from the blower within the hose is at a rate sufficient to ensure that seed is picked up from the receptacle and moved through the hose to the ground surface.

5. Apparatus as claimed in claim 1 wherein the seed flow control means includes a baffle movably covering the seed flow opening to control of seed flow from the receptacle through the hose to the ground surface.

6. Apparatus as claimed in claim 2 wherein the air flow from the blower within the hose is at a rate sufficient to ensure that seed is picked up from the receptacle and moved through the hose to the ground surface.

7. Apparatus as claimed in claim 3 wherein the air flow from the blower within the hose is at a rate sufficient to ensure that seed is picked up from the receptacle and moved through the hose to the ground surface.

8. Apparatus as claimed in claim 5 wherein the receptacle is releasable securable to the hose.

9. Apparatus as claimed in claim 8 wherein the hose first and second ends can be secured to each other after the receptacle has been removed so that the apparatus can operate as an air blower.
